(19) United States
(12) Patent Application Publication
(10) Pub. No.: US 2026/0253819 A1
(43) Pub. Date: Aug. 27, 2026

(54) ROTARY ANNULAR SWITCH FOR AN ELECTRIC TOOL

(71) Applicant: INFAR INDUSTRIAL CO., LTD., CHANG-HWA (TW)

(72) Inventor: Tai-Hung CHEN, CHANG-HWA (TW)

(21) Appl. No.: 19/204,581

(22) Filed: May 11, 2025

(30) Foreign Application Priority Data
Feb. 26, 2025 (TW) 114201955

(51) Int. Cl. H01H 19/14; B25F 5/02; H01H 19/04; H01H 19/36

(52) U.S. Cl. CPC H01H 19/14; B25F 5/02; H01H 19/04; H01H 19/36; H01H 2231/048

(57) ABSTRACT

A rotary annular switch for an electric tool is provided, which primarily enables a second electrode plate to be moved relative to a first electrode plate, and provides a resetting force through an elastic member, so as to ensure that when a user rotates an outer ring, the second electrode plate and the first electrode plate overlap or align radially, closing the circuit between a battery and a drive source, and when the user releases the outer ring, the elastic member causes the second electrode plate to move, ensuring misalignment of the second electrode plate with the first electrode plate and opening the circuit between the battery and the drive source, thereby reliably turning off the electric tool.

### BACKGROUND

### Field of the Invention

The present invention relates to an electric tool, and more particularly to a rotary annular switch for an electric tool.

### Description of Related Art

Electric tools commonly employ push-button switches as their activation mechanisms, yet this conventional design harbors several safety concerns. Once a user presses the switch, the tool remains in operation until manually turned off. While this design offers operational convenience, it introduces latent hazards. For example, an operator might forget to turn off the switch in a hurry and leave the work area, leading to the still-operating electric tool potentially colliding with the surrounding environment. Such incidents can not only damage the tool itself or adjacent equipment but also pose risks of injury to passerby.

Another notable design flaw is that these push-button switches typically protrude from the grip surface, increasing the likelihood of accidental activation. In crowded work environments, the tool might be inadvertently activated by accidental contact, creating dangerous situations. Given these safety considerations, the existing push-button switch design clearly warrants improvement to enhance the safety and reliability of tool operation.

### SUMMARY

The present invention provides a rotary annular switch for an electric tool, the main objective of which is to prevent accidental activation and to be able to automatically turn off, so as to enhance safety.

To achieve the above objective, a rotary annular switch for an electric tool provided by the invention comprises:
a housing, including a first body section, a recessed section, and a second body section sequentially connected, wherein an annular groove is formed between the first body section and the second body section, and the annular groove corresponds to the recessed section;
an elastic member, sleeved over the recessed section and located within the annular groove, the elastic member including a first end and a second end opposite to each other, wherein the first end is fixedly connected to the housing;
at least one first electrode plate, fixedly disposed within the annular groove, the at least one first electrode plate being located outside the elastic member, and the elastic member being positioned between the at least one first electrode plate and the recessed section;
an outer ring, rotatably sleeved over the recessed section, the outer ring being located outside the elastic member and the at least one first electrode plate, the outer ring having an inner circumferential surface, and the outer ring being rotatable between a first position and a second position, wherein the second end is connected to the outer ring;
at least one second electrode plate, attached to the inner circumferential surface of the outer ring;
a battery, electrically connected to the at least one first electrode plate; and
a drive source, electrically connected to the battery and the at least one second electrode plate;
whereby, when the outer ring is in the first position, the at least one second electrode plate and the at least one first electrode plate are misaligned, and a circuit between the battery and the drive source is open; and when the outer ring is in the second position, the at least one first electrode plate and the at least one second electrode plate are electrically connected, and the circuit between the battery and the drive source is closed.

From the above, it is clear that the present invention primarily enables the second electrode plate to be moved relative to the first electrode plate, and provides a resetting force through the elastic member, which ensures that when the user rotates the outer ring, the second electrode plate and the first electrode plate overlap or align radially, closing the circuit between the battery and the drive source, and when the user releases the outer ring, the elastic member causes the second electrode plate to move, ensuring misalignment of the second electrode plate with the first electrode plate and opening the circuit between the battery and the drive source, thereby reliably turning off the electric tool.

### BRIEF DESCRIPTION OF THE DRAWINGS

FIG. 1 is an exploded view of the rotary annular switch of an electric tool of the present invention;

FIG. 2 is a three-dimensional schematic diagram of the rotary annular switch of the electric tool of the present invention;

FIG. 3 is a sectional view of the rotary annular switch of the electric tool of the present invention;

FIG. 4 is a sectional view of the rotary annular switch of the electric tool of the present invention from another angle;

FIG. 5 is a three-dimensional schematic diagram of the rotary annular switch of the electric tool of the present invention;

FIG. 6 is a sectional view of the rotary annular switch of the electric tool of the present invention;

FIG. 7 is a sectional view of the rotary annular switch of the electric tool of the present invention from another angle; and

FIG. 8 is a circuit schematic diagram of the rotary annular switch of the electric tool of the present invention.

### DETAILED DESCRIPTION

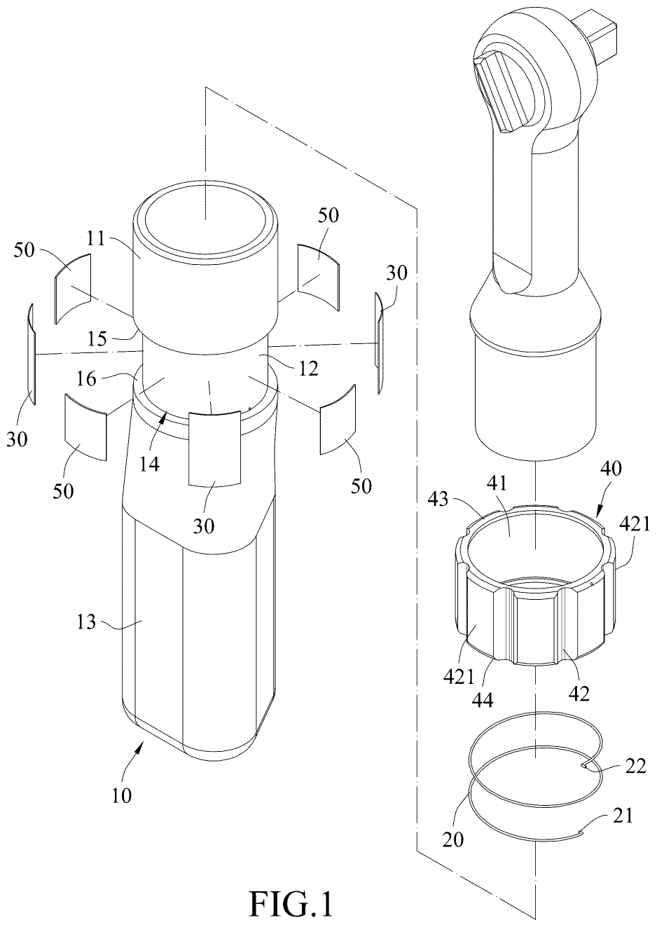

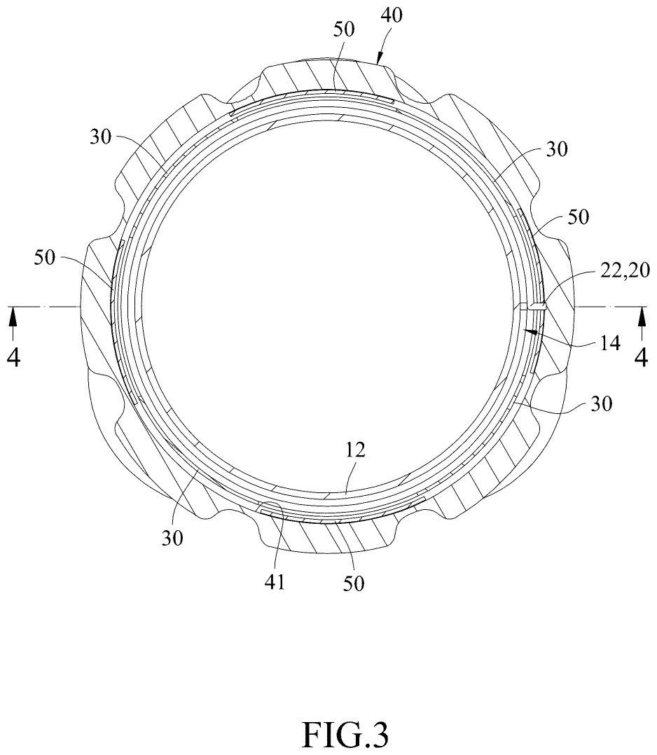

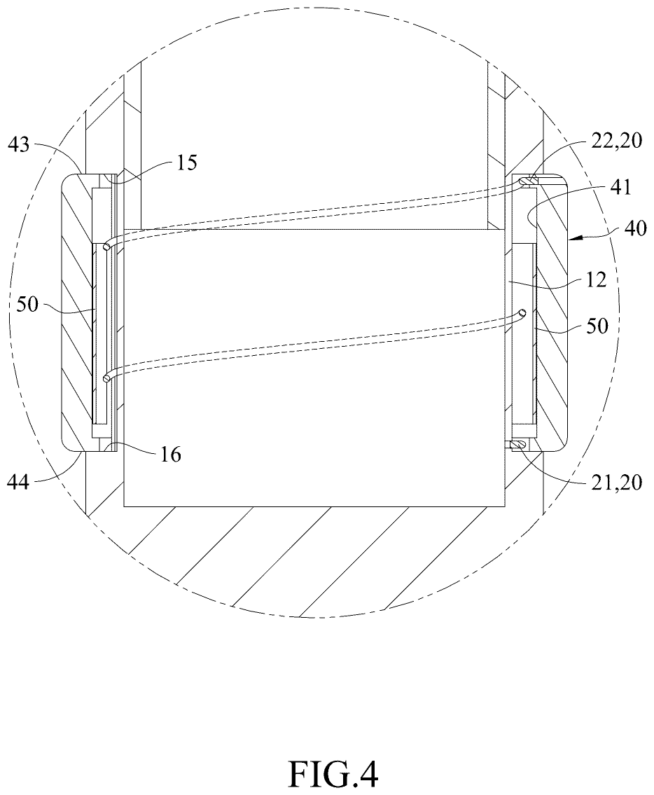

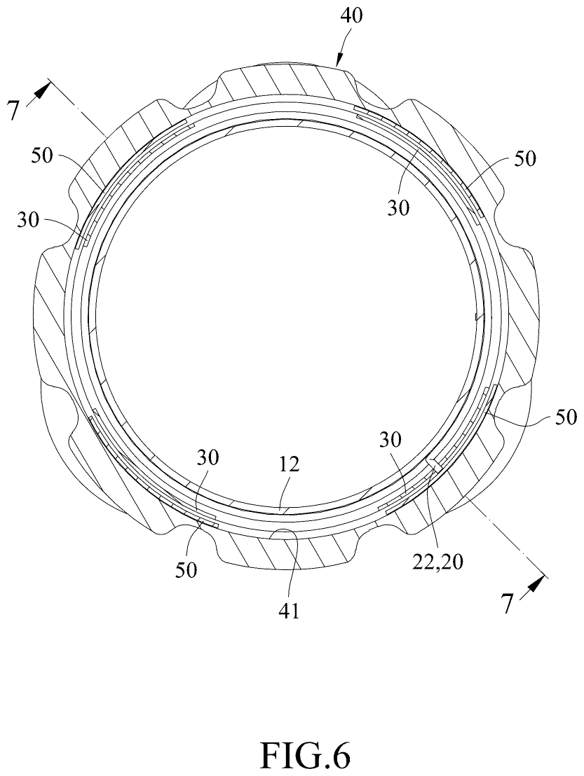

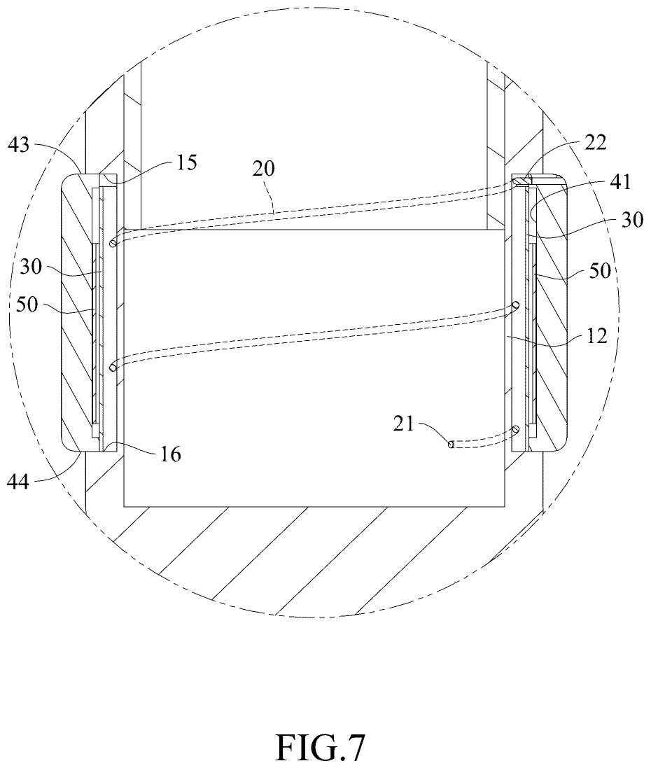

The present invention provides a rotary annular switch for an electric tool. As shown in FIGS. 1 to 8, the switch includes:

A housing 10, comprising a first body section 11, a recessed section 12, and a second body section 13 sequentially connected. The cross-sections of the first body section 11 and the second body section 13 are larger than that of the recessed section 12, forming an annular groove 14 between the first body section 11 and the second body section 13, which corresponds to the recessed section 12.

An elastic member 20, sleeved over the recessed section 12 and located within the annular groove 14. The elastic member 20 may be a helical spring, having a first end 21 and a second end 22 opposite to each other. The first end 21 is fixedly connected to the housing 10. In this embodiment, the first end 21 is inserted into the recessed section 12.

A first electrode plate 30, fixedly disposed within the annular groove 14. The first electrode plate 30 is located outside the elastic member 20, such that the elastic member 20 is positioned between the first electrode plate 30 and the recessed section 12. In a preferred embodiment, the housing 10 further includes a first inner end surface 15 and a second inner end surface 16 facing each other, located on opposite sides of the annular groove 14. The first inner end surface 15 and the second inner end surface 16 are annular. The first inner end surface 15 is located at the end of the first body section 11 connecting to the recessed section 12, and the second inner end surface 16 is located at the end of the second body section 13 connecting to the recessed section 12. One end of the first electrode plate 30 is inserted into the first inner end surface 15, and the other end is inserted into the second inner end surface 16, thereby fixing the first electrode plate 30 within the annular groove 14.

An outer ring 40, rotatably sleeved over the recessed section 12, located outside the elastic member 20 and the first electrode plate 30. The outer ring 40 has an inner circumferential surface 41 and an outer circumferential surface 42 opposite to each other, with the inner circumferential surface 41 spaced apart from the recessed section 12. The outer ring 40 has a top end surface 43 and a bottom end surface 44 opposite to each other. The top end surface 43 abuts against the first inner end surface 15, and the bottom end surface 44 abuts against the second inner end surface 16. The outer ring 40 can rotate between a first position and a second position, and is normally located in the first position. The second end 22 of the elastic member 20 is fixedly connected to the outer ring 40, allowing the second end 22 to move together with the outer ring 40. In a preferred embodiment, the outer circumferential surface 42 includes a plurality of protrusions 421 spaced apart to provide a firm grip for the user.

A second electrode plate 50, attached to the inner circumferential surface 41 of the outer ring 40. The number of second electrode plates 50 is the same as that of the first electrode plates 30. In this embodiment, there are four first electrode plates 30 and four second electrode plates 50, spaced apart and attached to the inner circumferential surface 41.

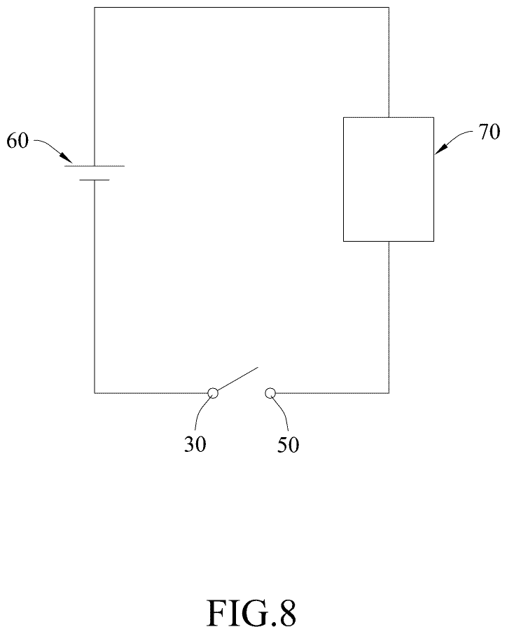

As shown in FIG. 8, a battery 60 is provided within the housing 10, electrically connected to the first electrode plate 30.

A drive source 70, located within the housing 10, electrically connected to the battery 60 and the second electrode plate 50. In this embodiment, the drive source 70 is a motor.

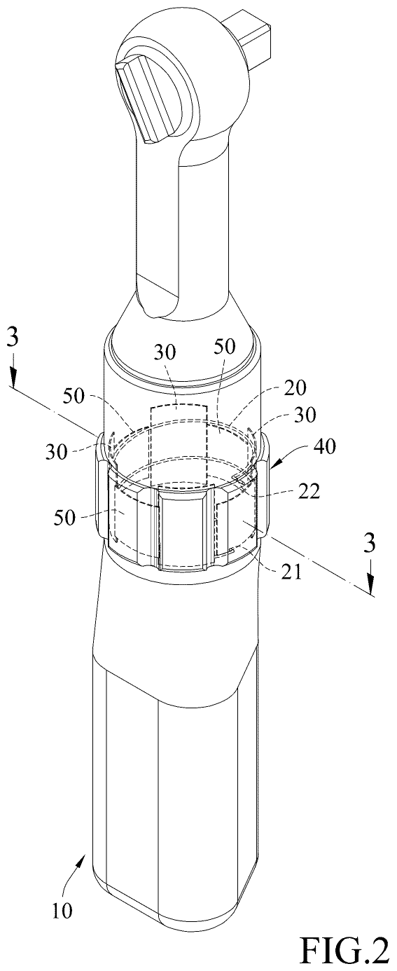

As shown in FIGS. 2 to 4, when the outer ring 40 is not rotated by the user and is in the first position, the second electrode plate 50 and the first electrode plate 30 are misaligned, and the elastic member 20 is neither compressed nor stretched. At this time, the circuit between the battery 60 and the drive source 70 is open.

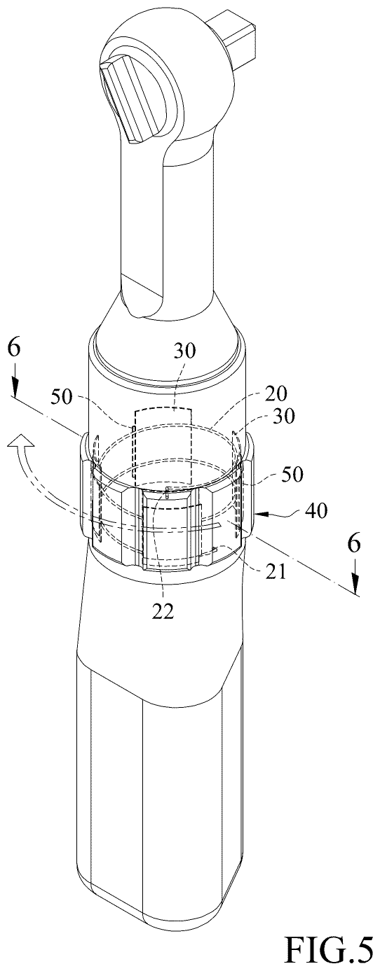

As shown in FIGS. 5 to 7, when the outer ring 40 is rotated by the user and is in the second position, the second electrode plate 50 and the first electrode plate 30 overlap or align radially, establishing an electrical connection between the first electrode plate 30 and the second electrode plate 50. The elastic member 20 is either compressed or stretched, and the circuit between the battery 60 and the drive source 70 is closed, activating the drive source 70.

When the user releases the outer ring 40, the elastic member 20 causes the outer ring 40 to rotate back to the first position, misaligning the second electrode plate 50 and the first electrode plate 30, thereby opening the circuit between the battery 60 and the drive source 70 to securely turn off the electric tool.

From the above, it is clear that the present invention primarily enables the second electrode plate 50 to be moved relative to the first electrode plate 30, and provides a resetting force through the elastic member 20, which ensures that when the user rotates the outer ring 40, the second electrode plate 50 and the first electrode plate 30 overlap or align radially, closing the circuit between the battery 60 and the drive source 70, and when the user releases the outer ring 40, the elastic member 20 causes the second electrode plate 50 to move, ensuring misalignment of the second electrode plate 50 with the first electrode plate 30 and opening the circuit between the battery 60 and the drive source 70, thereby reliably turning off the electric tool.

What is claimed is:

1. A rotary annular switch for an electric tool, comprising:
a housing, including a first body section, a recessed section, and a second body section sequentially connected, wherein an annular groove is formed between the first body section and the second body section, and the annular groove corresponds to the recessed section;
an elastic member, sleeved over the recessed section and located within the annular groove, the elastic member including a first end and a second end opposite to each other, wherein the first end is fixedly connected to the housing;
at least one first electrode plate, fixedly disposed within the annular groove, the at least one first electrode plate being located outside the elastic member, and the elastic member being positioned between the at least one first electrode plate and the recessed section;
an outer ring, rotatably sleeved over the recessed section, the outer ring being located outside the elastic member and the at least one first electrode plate, the outer ring having an inner circumferential surface, and the outer ring being rotatable between a first position and a second position, wherein the second end is connected to the outer ring;
at least one second electrode plate, attached to the inner circumferential surface of the outer ring;
a battery, electrically connected to the at least one first electrode plate; and
a drive source, electrically connected to the battery and the at least one second electrode plate;
whereby, when the outer ring is in the first position, the at least one second electrode plate and the at least one first electrode plate are misaligned, and a circuit between the battery and the drive source is open; and when the outer ring is in the second position, the at least one first electrode plate and the at least one second electrode plate are electrically connected, and the circuit between the battery and the drive source is closed.

2. The rotary annular switch for the electric tool as claimed in claim 1, wherein cross-sections of the first body section and the second body section are larger than a cross-section of the recessed section.

3. The rotary annular switch for the electric tool as claimed in claim 1, wherein the elastic member is a helical spring.

4. The rotary annular switch for the electric tool as claimed in claim 1, wherein the first end is inserted into the recessed section, and the second end is fixedly connected to the inner circumferential surface of the outer ring.

5. The rotary annular switch for the electric tool as claimed in claim 1, wherein the outer ring includes an outer circumferential surface opposite to the inner circumferential surface, and the outer circumferential surface is provided with a plurality of protrusions spaced apart from each other.

6. The rotary annular switch for the electric tool as claimed in claim 1, wherein the housing further includes a first inner end surface and a second inner end surface facing each other, the first inner end surface is located at an end of the first body section connecting to the recessed section, the second inner end surface is located at an end of the second body section connecting to the recessed section, one end of the at least one first electrode plate is inserted into the first inner end surface, another end of the at least one first electrode plate is inserted into the second inner end surface, the outer ring includes a top end surface and a bottom end surface opposite to each other, the top end surface abuts against the first inner end surface, and the bottom end surface abuts against the second inner end surface.

7. The rotary annular switch for the electric tool as claimed in claim 1, wherein the number of the at least one second electrode plate is the same as that of the at least one first electrode plate.

8. The rotary annular switch for the electric tool as claimed in claim 1, wherein there are four said first electrode plates and four said second electrode plates, and the second electrode plates are spaced apart and attached to the inner circumferential surface.
